(19) United States
(12) Patent Application Publication
(10) Pub. No.: US 2007/0152771 A1
(43) Pub. Date: Jul. 5, 2007

(54) Apparatus and method of via-stub resonance extinction

(76) Inventors: Lei Shan, Yorktown Heights, NY (US); Jeannine Trewhella, Peekskill, NY (US)

Correspondence Address: KEUSEY, TUTUNJIAN & BITETTO, P.C., 20 CROSSWAYS PARK NORTH, SUITE 210, WOOBURY, NY, 11797, US

(21) Appl. No.: 11/325,794

(22) Filed: Jan. 5, 2006

(51) Int. Cl. H01P 5/02

(52) U.S. Cl. 333/33

(57) ABSTRACT

An apparatus includes a multi-layer printed circuit board having a first through-hole via for a signal connection and a second through hole via for power/ground connections. The printed circuit includes a transmission line connected to at least one through-hole via. A resistor is connected between the first and second through-hole vias to eliminate a resonance notch and achieve a flat frequency response for insertion loss.

### BACKGROUND

1. Technical Field

The present invention relates to printed circuit boards (PCBS) and more particularly to improving electrical performance of PCBs with plated-through-holes (PTH) for connections among layers.

2. Description of the Related Art

Electronic packaging has become a bottle neck that limits electrical performance of both digital and analog systems. With the ever increasing operating speed/frequency or decrease in signal propagating wavelength, the effects of small features, which were negligible in the past, are now becoming critical and even detrimental to signal integrity. One of the most significant examples is the vertical interconnects used in printed circuit boards (PCBs), also known as vias, which disturb electromagnetic wave propagation and therefore introduce transmission and reflection losses.

Further, when plated through holes (PTH) are used as in today's prevalent PCB technology and signal traces are connected intermittently, the excessive via-stub (section below signal layer) may introduce parasitic LC resonances and result in detrimental losses in the multi-GHz frequency range. This jeopardizes signal integrity of such systems as servers, routers, etc. As a result, various approaches have been pursued to mitigate the negative effects of via stubs, including back-drill (remove via stubs from the bottom side of PCB) and build-up technologies for blind vias, etc. However, back-drill not only increases cost but also affects mechanical stability of the board, and blind vias require a future technology and will result in much higher manufacturing costs.

Multi-layer printed circuit boards (PCBs) are widely used in electrical systems, and often include metal lines and plated-through-hole (PTH) vias for signal and power/ground interconnections. PTHs are often employed in connecting to transmission lines in the PCB structure.

Referring to FIG. 1, a partial cross-sectional view of a PCB 4 having a chip or electronic device 1 coupled thereto is shown. Electronic device 1 is connected to a multi-layer PCB 4, with plural joints 2 to establish electrical connections between electronic device 1 and PCB 4. A PTH via 3 is used for signals and connected to a transmission line 6 located on or near a surface of an internal layer of the PCB 4. PTH via 5 is connected to ground/power planes within the PCB 4.

Since sections of via 3 below transmission lines 6 are not on the path of signal propagation, this portion of the via is usually called a “via stub” 15. The use of PTH vias tends to introduce excessive via sections or via stubs.

The length of a via stub is determined by a layer that the connected transmission line is located on. The parasitic capacitance and inductance due to these via stubs 15 results in LC resonances, whose frequencies vary with stub lengths. These LC resonances significantly increase insertion and reflection losses, and therefore become a main limiting factor for high-speed and multi-layer PCB applications.

### SUMMARY

Methods and apparatuses disclosed herein utilize surface-mount or integral shunt resistors attached to the external pads of a signal-via and ground-via on the stub side or at an internal level close to the end of a via stub, so that a Q-factor of such resonances is dramatically reduced, and therefore relatively “flat” transmission response is achieved in an extended frequency range.

Reflection loss may also be reduced significantly at the resonance frequency. A resonance extinction resistor virtually converts a “non-working” link into a performance link without changing the PCB design and technology.

An apparatus includes a multi-layer printed circuit board having a first through-hole via for a signal connection and a second through hole via for power/ground connections. The printed circuit includes a transmission line connected to at least one through-hole via. A resistor is connected between the first and second through-hole vias to eliminate a resonance notch and achieve a flat frequency response for insertion loss when an integrated circuit chip is connected to the through-hole vias in operation.

These and other objects, features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 is an illustrative cross-section of a conventional printed circuit board using plated-through-holes as vertical interconnects among layers;

FIG. 2 is an illustrative cross-section of a printed circuit board with surface-mount resonance extinction resistors in accordance with embodiments of the present disclosure;

FIG. 3 is an illustrative cross-section of a printed circuit board with surface-mount resonance extinction resistors, with offset surface bonding pads in accordance with embodiments of the present disclosure;

FIG. 4 is an illustrative cross-section of a press-fit connector mounted on a printed circuit board surface mount resonance extinction resistors in accordance with embodiments of the present disclosure;

FIG. 5 is an illustrative cross-section of a printed circuit board with integrated resonance extinction resistors in accordance with embodiments of the present disclosure;

FIG. 6 is an illustrative cross-section of a printed circuit board with resonance extinction resistors on both sides in accordance with embodiments of the present disclosure;

FIG. 7 is an S-parameter plot showing improvement in insertion loss after applying extinction resistors to a hardware prototype in accordance with embodiments of the present disclosure.

### DETAILED DESCRIPTION OF PREFERRED EMBODIMENTS

Exemplary embodiments of the present invention extinguish deep resonance notches due to via-stub LC resonance, so that both insertion loss and reflection may be reduced significantly, and electrical performance is improved. In one implementation, an extinction resistor is employed, which helps eliminate the resonance notch and achieve a desirable flat frequency response.

One application of such resonance extinction resistors employs surface-mount or integral resistors. In the case of surface-mount resistors, proper size and resistance may be used, and the resistor may be directly soldered onto existing external pads of a PCB, which guarantees backward compatibility.

As an example, in a via field of 1 mm pitch, which is common in existing packaging technologies, 0402 surface-mount resistors may be applied to a signal pad and an adjacent power/ground pad at the via-stub side (normally bottom side) without any modifications. Otherwise, additional solder pads may be added at the design stage to receive the resonance extinction resistors, or other size/type of resistors may be used to match a specific via pitch/pattern. An alternative is to use integrated internal resistors at a level that is close to the end of a via-stub. These resistors may be connected to signal vias at one end and power/ground planes at the other.

The assembly as described herein includes PCBs which may include one or more integrated circuit chips. The PCB design may be created in a graphical computer programming language, and stored in a computer storage medium (such as a disk, tape, physical hard drive, or virtual hard drive such as in a storage access network). If the designer does not fabricate PCBs or populated PCB assemblies or the photolithographic masks used to fabricate these items, the designer transmits the resulting design by physical means (e.g., by providing a copy of the storage medium storing the design) or electronically (e.g., through the Internet) to such entities, directly or indirectly. The stored design is then converted into the appropriate format (e.g., GDSII) for the fabrication of photolithographic masks, which typically include multiple copies of the chip design in question that are to be formed on a wafer. The photolithographic masks are utilized to define areas of the wafer or board (and/or the layers thereon) to be etched or otherwise processed.

The resulting PCB can be distributed by the fabricator as a single PCB or in a packaged form with chips. In the latter case an integrated circuit chip or chips are mounted in a single chip package (such as a plastic carrier, with leads that are affixed to the PCB or other higher level carrier by joints) or in a multichip package (such as a ceramic carrier that has either or both surface interconnections or buried interconnections). In any case the chip is then integrated with other chips, discrete circuit elements, and/or other signal processing devices as part of either (a) an intermediate product, such as a motherboard, or (b) an end product. The end product can be any product that includes integrated circuit chips and/or PCBs, ranging from toys and other low-end applications to advanced computer products having a display, a keyboard or other input device, and a central processor.

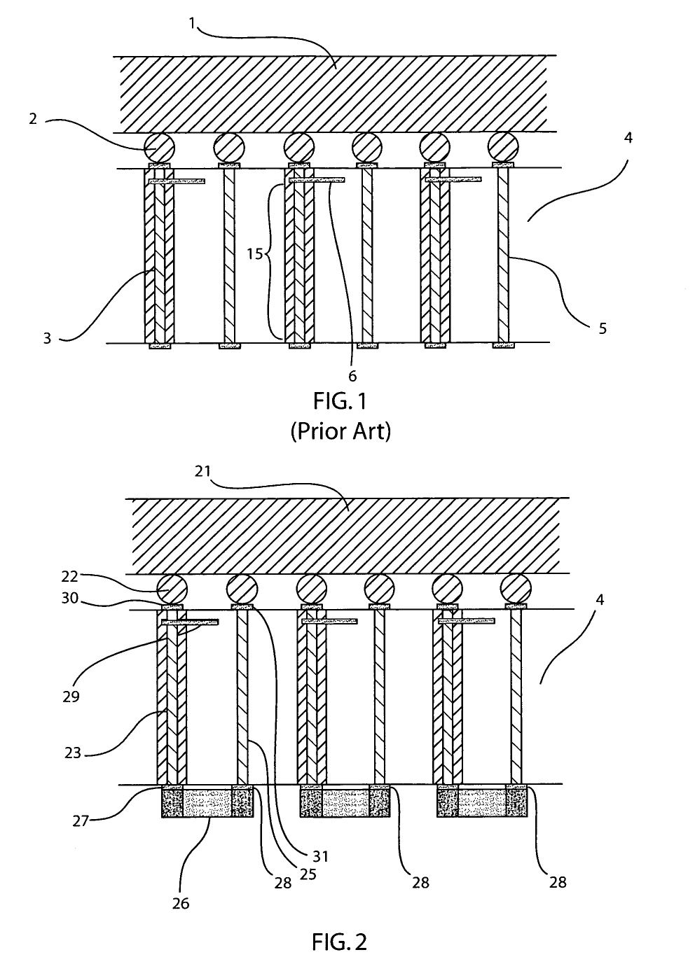

Referring now to the drawings in which like numerals represent the same or similar elements and initially to FIG. 2, a cross-section of a printed circuit board 24 with the addition of surface mount resonance extinction resistors 26 is illustratively shown from one exemplary embodiment. Electronic package/device 21 is attached to multiple external pads on printed circuit board 24 through electrical joints 22. Electrical joints 22 may be solder balls, columns, sockets, and/or other attaching mechanisms. Via 23 is connected to a signal pin on electronic package/device 21 through electrical joint 22 and surface pad 20 at a top side of the printed circuit board 24, and to signal trace 29 on a surface or internal layer of printed circuit board 24. Via 25 is connected to a power/ground pin on electronic package/device 21 through electrical joint 22 and surface pad 31 at top side of printed circuit board 24, and to power/ground planes on surface or internal layers of the printed circuit board 24.

The resonance extinction resistor 26 is directly soldered onto external pads 27 and 28 of via 23 and via 25 on the bottom side of the printed circuit board 24. The proper size surface mount resistor should be employed to match the pitch of via 23 and via 25. Vias 23 and 25 may include plated-through-holes (PTH).

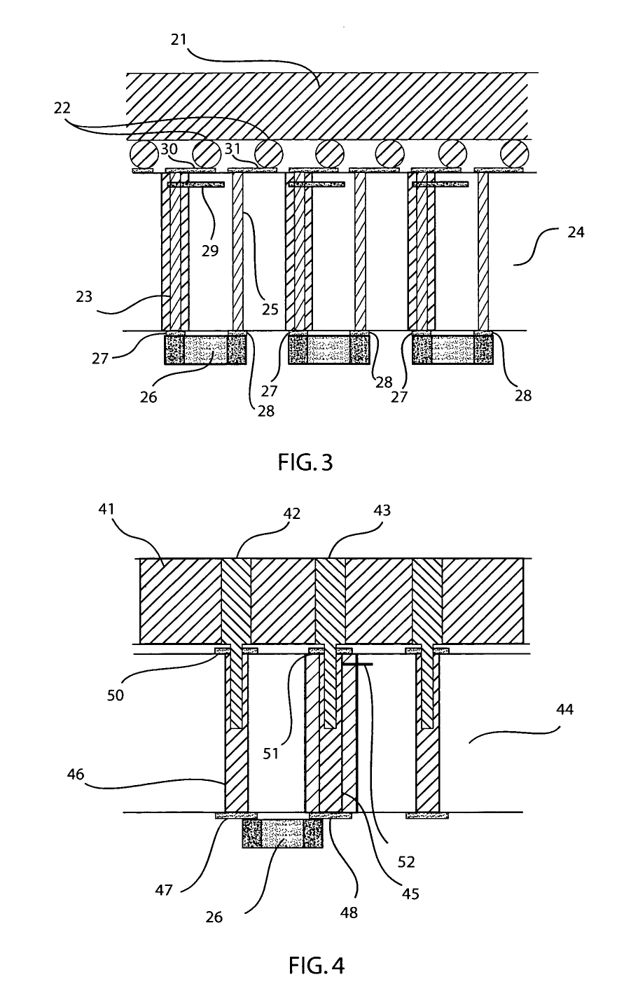

Referring to FIG. 3, an alternate configuration is shown with the external pads 30 and 31 offset from vias 23 and 25 to provide a smooth surface without via holes from vias 23 and 25 in the center.

Referring to FIG. 4, a press-fit connector 41 is mounted on a printed circuit board 44 with the addition of surface mount resonance extinction resistors 26. Connector 41 is attached to printed circuit board 44 through press-fit pins 42 and 43, which pass into board 44 passed plates or pads 50 and 51. Via 45 is connected to signal pin 43 of connector 41 and to signal trace 52 on a surface or internal layer of printed circuit board 44. Via 46 is connected to power/ground pin 42 of connector 41 and to power/ground planes on surface or internal layers of printed circuit board 44. Resonance extinction resistor 26 is directly soldered onto the external pads 47 and 48 of via 46 and via 45 on the bottom side of printed circuit board 44. Proper size surface mount resistors should be employed to match the pitch of via 46 and via 45.

Referring to FIG. 5, a cross-section of a printed circuit board 64 with the addition of integrated resonance extinction resistors 66 is illustratively shown. Electronic package 61, that carries electronic device(s), is attached to multiple external pads 48 on printed circuit board 64 through electrical joints 62. Electrical joints 62 may be solder balls, columns, sockets, and/or other attaching mechanisms. Via 63 is connected to a signal pin on electronic package 61 through electrical joint 62 and surface pad 68 at top side of the printed circuit board 64, and to signal trace 67 on a surface or internal layer of printed circuit board 64. Via 65 is connected to a power/ground pin on electronic package 61 through electrical joint 62 and surface pad 69 at top side of printed circuit board 64, and to power/ground planes on surface or internal layers of the printed circuit board 64.

An integrated resonance extinction resistor 66 is fabricated on an internal layer close the bottom side of printed circuit board 64, and connects via 63 to a power/ground plane on the same layer. In this embodiment, the resistor 66 may be part of the PCB 64 design or applied during the fabrication of the assembly (e.g., attaching layers of printed circuit boards together).

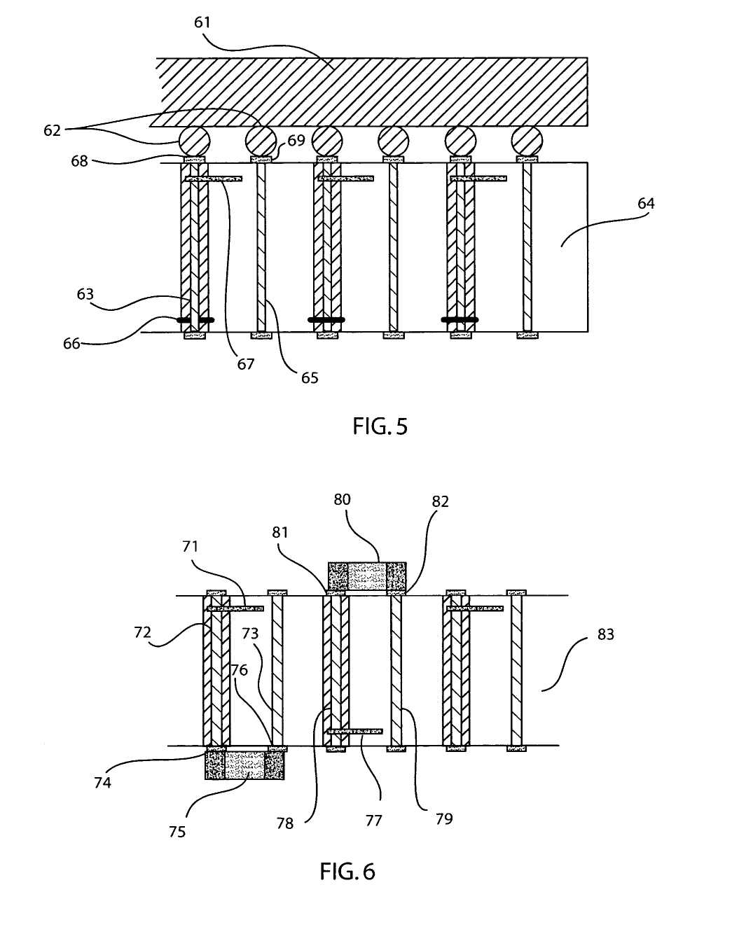

Referring to FIG. 6, a cross-section of a printed circuit board 83 with the addition of resonance extinction resistors 75 and 80 on both sides of the board 83 is illustratively shown in accordance with another embodiment. Resonance extinction resistor 75 is attached to surface pads 74 and 76 on the bottom side of the printed circuit board 83. Resonance extinction resistor 80 is attached to surface pads 81 and 82 on the top side of the printed circuit board 83. Vias 72 and 78 are signal vias connected to signal traces 71 and 77 on a surface of internal layers. Vias 73 and 79 are power/ground vias connected to surface or internal power/ground planes.

As an example, for a 24-layer and 4.2 mm thick board, a via stub (3.9 mm long) may introduce a resonance at approximately 6.2 GHz. At this resonance frequency, insertion loss is as high as −30 dB, and reflection loss is −0.46 dB or 97.5% energy is reflected. For a system link that includes such via stubs, operating below 3 GHz requires carefully constructed designs, and operating above 3GHz is almost impracticable. Further analysis reveals that sub-resonances occur at even lower frequency when such via-stubs are cascaded with low-loss transmission lines, e.g., inter-via resonances.

By applying a resonance extinction resistor, e.g. 50 ohm, insertion loss is lowered to −5 dB and reflection loss to −10 dB, a deterministic improvement for high-speed links. Similar results were also obtained in hardware measurements as will be described below. The selection of the resonance extinction resistance should depend on resonance frequency as well as frequencies of interest. The outcome can be either uniform transmission or minimized losses within certain frequency range.

Properly sized surface-mount resistors may be directly soldered onto existing external pads at the via stub ends, which offers backward compatibility. As an example, in a via field of 1 mm pitch, which is very common in existing packaging technologies, 0402 surface-mount chip resistors may be used without any modifications. Otherwise, additional solder pads may be added at the design stage to receive the resonance extinction resistors. An alternative is to employ integrated internal resistors at a level that close to the end of a via stub.

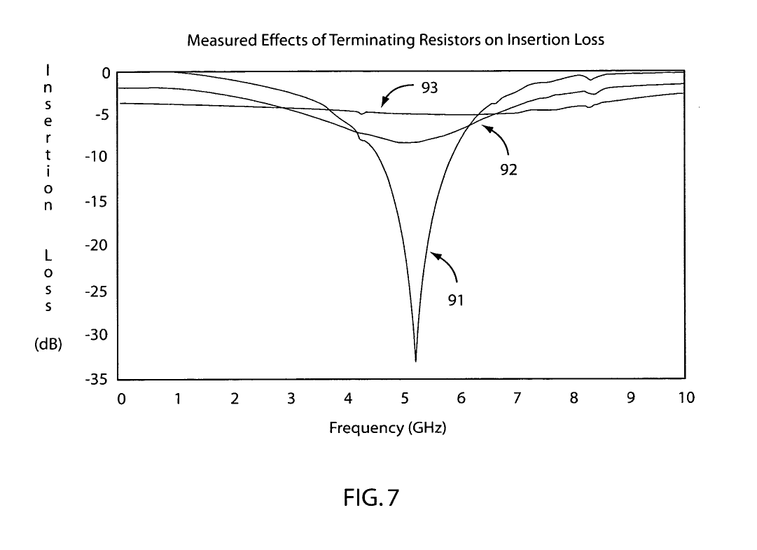

Referring to FIG. 7, the effects of the present invention are illustrated with measurements on a test prototype. A via stub length for the prototype was 3.9 mm, and the board thickness was 4.2 mm. The LC resonance frequency was 5.2 GHz with a notch of −32 dB. In this particular case, a 50 ohm extinction resistor was employed to help eliminate the resonance notch and achieve a desirable flat frequency response. Extinction resistors may be selected in accordance with the resonance effects caused by for example LC resonance of transmissions lines as described above. Low resistance value tends to increase low-frequency loss, while high resistance value may lead to insufficient resonance extinction.

FIG. 7 illustratively shows the effects of the present invention on electrical performance of a via field. Transmission curve 91 shows a 5.2 GHz resonance for a signal via with a 4 mm stub. The resonance significantly increases insertion loss and turns the signal path off at the resonance frequency. With the addition of a 100 ohm resonance extinction resistor, the resonance notch becomes much shallower, down to −8 dB from −32 dB, as shown in transmission curve 92. Transmission curve 93 shows that the resonance notch is further reduced to −5 dB (virtually flat) with the addition of a 50 ohm resonance extinction resistor. Other resistor sizes and values may also be employed.

Having described preferred embodiments of a device and method of via-stub resonance extinction (which are intended to be illustrative and not limiting), it is noted that modifications and variations can be made by persons skilled in the art in light of the above teachings. It is therefore to be understood that changes may be made in the particular embodiments disclosed which are within the scope and spirit of the invention as outlined by the appended claims. Having thus described aspects of the invention, with the details and particularity required by the patent laws, what is claimed and desired protected by Letters Patent is set forth in the appended claims.

What is claimed is:

1. An apparatus, comprising:
a multi-layer printed circuit board having a first through-hole via for a signal connection and a second through hole via for power/ground connections, the printed circuit including a transmission line connected to at least one through-hole via; and
a resistor connected between the first and second through-hole vias to eliminate a resonance notch and achieve a flat frequency response for insertion loss when an integrated circuit chip is connected to the through-hole vias in operation.

2. The apparatus as recited in claim 1, wherein the resistors are integrated in a layer of the printed wiring board.

3. The apparatus as recited in claim 1, wherein the transmission line is in proximity to a first side of the printed circuit board and the resistor is provided in proximity to a second side of the printed circuit board, opposite the first side.

4. The apparatus as recited in claim 1, wherein the transmission line includes a plurality of transmission lines and each transmission line includes a signal and power/ground via pair, and further comprising a resistor connecting between the via pair and disposed on an opposite side of the printed circuit board from each respective transmission line.

5. The apparatus as recited in claim 1, further comprising an integrated circuit chip connected to the first and second through-hole vias on a side opposite the resistor.

6. The apparatus as recited in claim 5, wherein the integrated circuit chip is connected to the first and second through-hole vias by contact pads and a connection joint.

7. The apparatus as recited in claim 6, wherein the connection joint is offset from a center of the contact pad.

8. The apparatus as recited in claim 5, wherein the integrated circuit chip is connected to the first and second through-hole vias by a press fit connection.

9. The apparatus as recited in claim 1, wherein the resistor is sized in accordance with a pitch dimension of the printed circuit board.

10. The apparatus as recited in claim 1, wherein the resistor includes a magnitude which reduces or eliminates LC resonance due to a via stub of the at least one through-hole via connected to the transmission line.

11. An apparatus, comprising:
a multi-layer printed circuit board having plated-through-hole vias for signal and power/ground connections;
a set of contact pads connected to the through-hole vias on a first external surface of the printed circuit board, and another set of contact pads connected to the through-hole vias on a second external surface of the printed circuit board opposite to the first external surface, the first set of contact pads being configured to receive an integrated circuit chip; and
a plurality of surface-mount resistors connected to the set of contact pads on the second external surface of the printed circuit board, one end of each resistor being connected to corresponding signal through-hole vias and the other end of each resistor being connected to adjacent power/ground through-hole vias.

12. The apparatus as recited in claim 11, further comprising an electronic device connected to the set of contact pads on the first external surface.

13. The apparatus as recited in claim 11, wherein the set of contact pads on the first external surface of the printed circuit board are offset from a center of the plated-through-hole vias.

14. The apparatus as recited in claim 11, wherein the resistors include a plurality of integrated internal resistors fabricated during printed circuit board manufacturing.

15. The apparatus as recited in claim 11, wherein the resistors include surface mount resistors.

16. The apparatus as recited in claim 11, wherein the through-hole vias are configured to receive contact pins and contact pins from an integrated circuit are press fit to make a connection to the printed circuit board.

17. The apparatus as recited in claim 11, wherein the resistors are connected to sets of contact pads on the first external surface and the second external surface of the printed circuit board.

18. The apparatus as recited in claim 11, wherein the printed circuit includes a transmission line connected to at least one through-hole via.

19. The apparatus as recited in claim 18, wherein the resistors include a magnitude which reduces or eliminates LC resonance due to a via stub of the at least one through-hole via connected to the transmission line.

20. The apparatus as recited in claim 11, wherein the resistors are sized in accordance with a pitch dimension of the printed circuit board.
